(19) United States
(12) Patent Application Publication
(10) Pub. No.: US 2010/0060448 A1
(43) Pub. Date: Mar. 11, 2010

(54) BABY MONITORING APPARATUS

(76) Inventors: Priscilla LARSEN, New Territories (HK); Vanessa LARSEN, Manly (AU)

Correspondence Address: OSTROLENK FABER GERB & SOFFEN, 1180 AVENUE OF THE AMERICAS, NEW YORK, NY, 100368403, US

(21) Appl. No.: 12/205,254

(22) Filed: Sep. 5, 2008

(51) Int. Cl. G08B 1/08; H04N 7/18

(52) U.S. Cl. 340/539.15; 340/573.1; 348/143; 348/E07.085

(57) ABSTRACT

The present invention provides a baby monitoring apparatus comprising a crib mobile unit having a baby monitor unit and a remote control unit, wherein the baby monitoring apparatus is adapted and configured to allow a two-way wireless communication between the remote control unit and the crib mobile unit.

### FIELD OF THE PRESENT INVENTION

The present invention is concerned with an apparatus to be put in proximity of a baby for monitoring their activities and/or providing response to the activities. The apparatus may be attached to a baby cot or any suitable location for monitoring the baby by the parent or to providing entertaining to the baby.

### BACKGROUND OF THE PRESENT INVENTION

Conventional baby crib mobiles have been around for a long time. The baby crib mobile is usually attached to a baby cot for playing music to soothe a baby. The crib mobile is typically provided with one or more characters which are movable or slowly move during the playing of music to entertain the baby. In recent years, some apparatus have been provided serving as a crib mobile and as a baby monitoring apparatus. For example, there has been around baby monitoring apparatus equipped with a microphone for receiving the sound from the baby. The sound is turned into a signal by the monitoring apparatus and the signal is receivable at a remote unit which can play the sound from the baby. With this configuration, the parent will be able to monitor if the baby in the baby cot, for example, is crying.

The present invention seeks to provide an improved baby monitoring apparatus to address the above problems, or at least to provide an alternative to the public.

### SUMMARY OF THE PRESENT INVENTION

According to a first aspect of the present invention, there is provided a baby monitoring apparatus comprising a crib mobile unit having a baby monitor unit and a remote control unit, wherein the baby monitoring apparatus is adapted and configured to allow a two-way wireless communication between the remote control unit and the crib mobile baby monitor unit. The feature of two-way communication in the apparatus is advantageous because it not only enables the parent to monitor the activities of the baby but also makes it possible for the parent to react to the activities remotely. The two-way wireless communication may preferably be for communication between the remote control unit and the baby monitor unit, and to control the crib mobile unit remotely.

In a preferred embodiment, the baby monitor unit may be detachable from the crib mobile unit, and when the baby monitor unit is detached from the crib mobile unit, the crib mobile unit may still be operable. In a more specific embodiment, when the baby monitor unit is detached from the crib mobile unit, the baby monitor unit may still be operable. One advantage with the detachable baby monitor unit is that the crib mobile without the baby monitor unit can still be operable to entertain a first baby. The detached baby monitor unit can be located in a different location for monitoring a second baby.

Suitably, the crib mobile and/or the baby monitor unit may include a speaker for playing a pre-programmed music and a microphone for capturing audio from the surrounding of the speaker. For embodiments with both the crib mobile and the baby monitor having speakers, they together may play one of the pre-programmed music selected by the parent. Alternatively, for embodiments, with a speaker at the crib mobile and not the baby monitor unit, only the speaker from the crib mobile and not the baby monitor unit can play the music regardless of whether the baby monitor unit is attached to the crib mobile or not.

In a preferred embodiment, the baby monitor unit may include a camera for capturing video or color video in the view of the camera. Specifically, the crib mobile and the baby monitor may be secured to the baby crib at a position such that the view of the camera can capture the entire area of the crib. Advantageously, the camera is configured to capture color video because a color video can provide more information to the parent when it comes to monitoring.

In another embodiment, the remote control unit may include a speaker for playing an audio corresponding to the audio captured by the microphone of the crib mobile or the monitor unit. With the microphone at the baby monitor and the speaker at the remote control unit, the parent can monitor, for example, whether the baby is crying.

Suitably, the remote control unit may include a video display for displaying a video or a color video corresponding to the video or color video captured by the camera of the crib mobile unit or the baby monitor unit. The use of a color video will be able to provide more information to the parent.

The baby monitoring apparatus may further comprise a plurality of controls in the form of buttons and sensory pads at the remote control unit and/or the baby monitor unit via which a user or the parent can provide instructions to the crib mobile unit for operation thereof. For example, the controls may be used to control movement of characters hung, playing of music or lighting at the crib mobile.

The configured may be configured to provide a recess for receiving a tongue-like protrusion from the crib mobile unit such that the baby monitor unit may be detachably secured to the crib mobile at the tongue.

The crib mobile unit and the baby monitor unit may be electrically connectable by a plurality of metallic contacts via which instructions about a desired operation of the crib mobile from the remote control unit or the baby monitor unit is fed to the crib mobile. In embodiments which the baby monitor is detachable from the crib mobile and when the baby monitor is detached, the crib mobile is operable on site at the crib mobile itself without the presence of the baby monitor unit or the use of the remote control unit.

According to a second aspect of the present invention, there is provided with a baby monitoring apparatus, comprising a crib mobile unit having a baby monitor unit and a remote control unit, wherein the baby monitor unit includes a camera for capturing video or color video in the view of the camera and/or a microphone for capturing audio from the surrounding of the microphone, and a first transmitter for transmitting a first wireless signal corresponding to the video and/or the audio, wherein the remote control unit includes a second receiver for receiving the first wireless signal, a second transmitter for transmitting a second wireless signal corresponding to instructions received by the remote control unit for operation of the crib mobile unit, and wherein the baby monitor unit further includes a first receiver for receiving the second wireless signal.

In a preferred embodiment, the baby monitor unit may be detachable from the crib mobile unit, and when the baby monitor unit is detached from the crib mobile unit, the baby monitor unit is operable.

Suitably, the crib mobile and/or the baby monitor unit include a speaker for playing a pre-programmed music and a microphone for capturing audio from the surrounding of the speaker.

In another embodiment, the baby monitor unit may include a camera for capturing video or color video in the view of the camera.

The remote control unit may include a speaker for playing an audio corresponding to audio captured by a microphone of the crib mobile or the monitor unit.

The remote control unit may include a video display for displaying a video or a color video corresponding to video or color video captured by a camera of the crib mobile unit or the baby monitor unit.

The baby monitoring apparatus may further comprise a plurality of controls at the remote control unit and the baby monitor unit via which a user can provide instructions to the crib mobile unit for operation thereof.

The baby monitor unit may be configured to provide with a recess for receiving a tongue from the crib mobile unit such that the baby monitor unit is detachably secured to the crib mobile at the tongue.

A baby monitoring apparatus as claimed in claim 13, wherein the crib mobile unit and the baby monitor unit are electrically connectable by a plurality of metallic contacts via which instructions is fed to the crib mobile for desired operation of the crib mobile from the remote control unit or baby monitor unit.

### BRIEF DESCRIPTION OF DRAWINGS OF THE PRESENT INVENTION

Some embodiments of the present invention will now be described by way of example and with reference to the accompanying drawings, in which:—

FIG. 1 is a schematic diagram showing a baby monitoring apparatus (or a crib mobile baby monitoring apparatus) and different views of a remote control unit for the baby monitoring apparatus according to an embodiment of the present invention;

FIGS. 2 to 4 are alternative views of the baby monitoring apparatus as shown in FIG. 1 but with characters attached thereto removed;

FIG. 5 is a side view of the baby monitoring apparatus as shown in FIG. 2 but with a baby monitor unit removed and without the remote control unit;

FIG. 6 is an enlarged side view showing part of the baby monitoring apparatus as shown in FIG. 5;

FIG. 7 is a front view of the baby monitoring apparatus as shown in FIG. 6;

FIG. 8 is a schematic perspective view of the baby monitor unit separated from the baby monitoring apparatus of FIG. 5;

FIG. 9 is a schematic view showing the front of the area of the baby monitoring apparatus to which the baby monitor unit is secured;

FIG. 10 is a simplified cross section view of part of the baby monitoring apparatus at A-A′ of FIG. 9;

FIG. 11 is a simplified cross section view of the baby monitoring apparatus taken from B-B′ of FIG. 6;

FIG. 12 is a rear view of the baby monitoring apparatus of FIG. 9;

FIG. 13 is a front view of the baby monitor unit;

FIG. 14 is a simplified cross section view of the baby monitor unit of FIG. 13;

FIG. 15 is a rear view of the baby monitor control unit of FIG. 13;

FIG. 16 is a simplified cross section view of the baby monitor unit taken at C-C′ of FIG. 14; and

FIG. 17 is a front view of the remote control unit sitting in a stand.

### DETAILED DESCRIPTION OF PREFERRED EMBODIMENTS OF THE PRESENT INVENTION

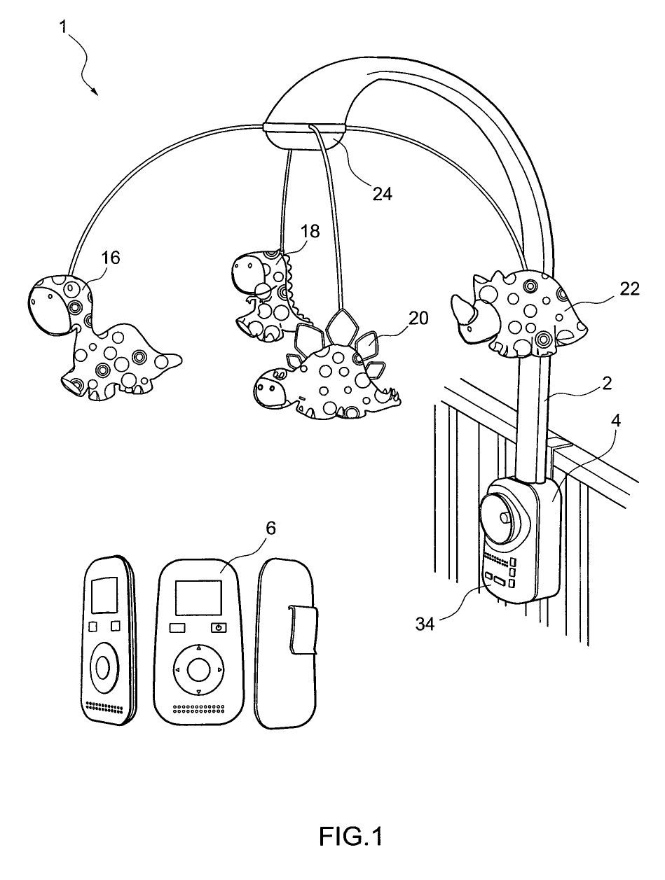

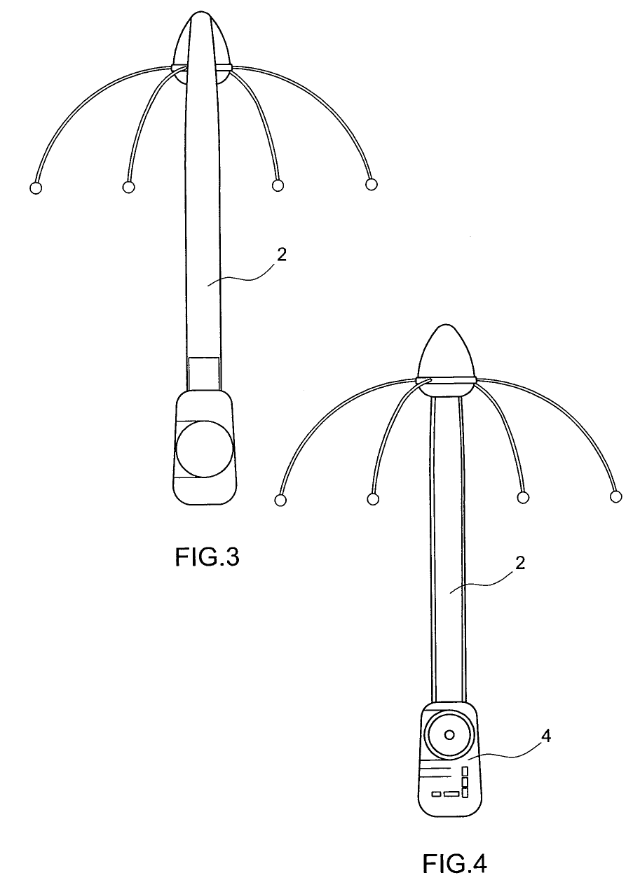

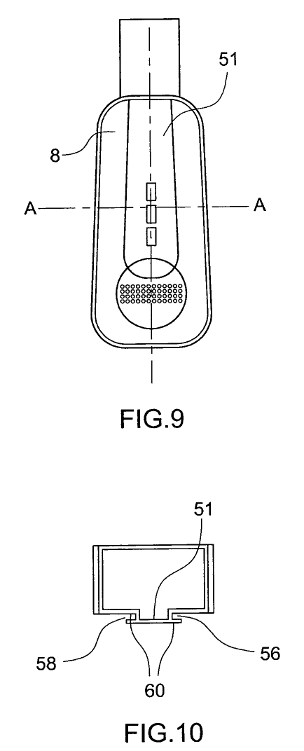

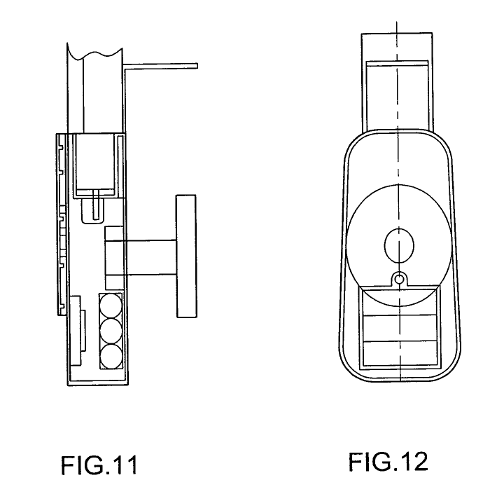

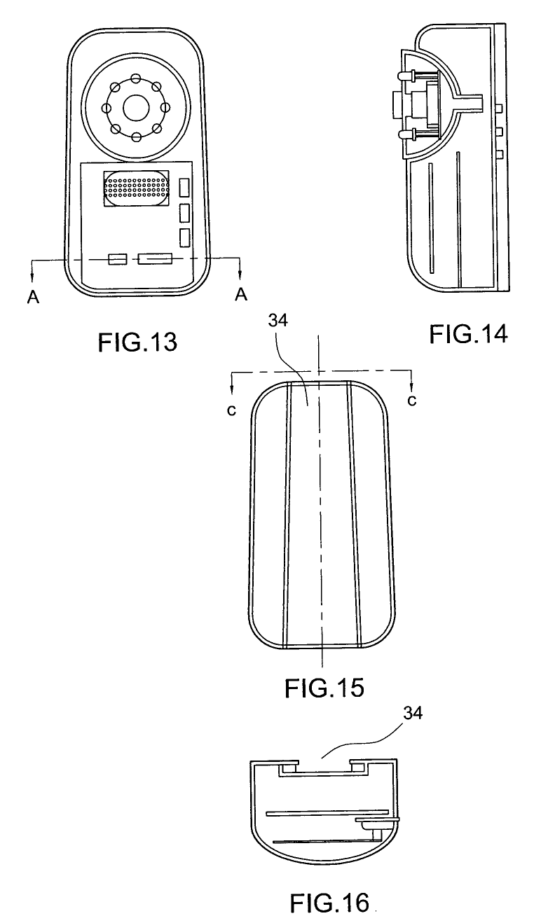

An embodiment of a baby monitoring apparatus according to the present invention is shown in FIGS. 1 to 17. For the purpose of this invention, the meaning of “baby’ comprises an infant, an older child or a person who requires attention such as a patient.

The baby monitoring apparatus, generally designated 1, is shown in FIG. 1. The monitoring apparatus 1 includes three main portions, namely a crib mobile 2, a monitor unit 4 and a remote control unit 6.

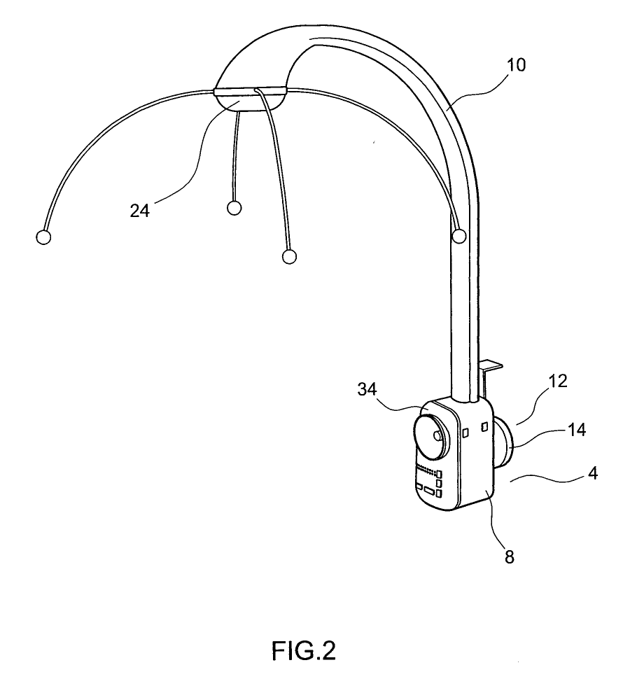

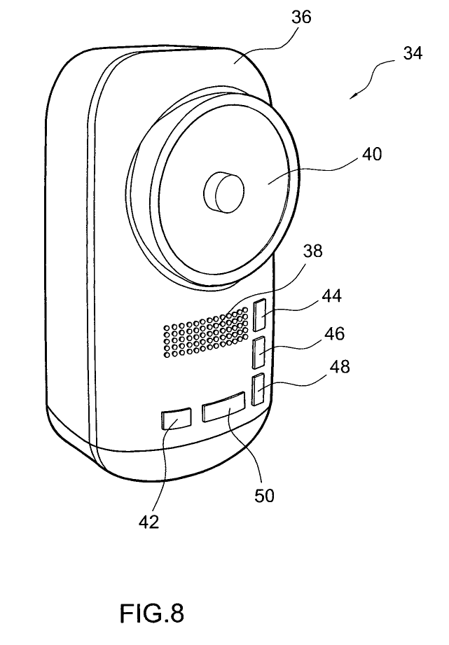

Referring to FIGS. 1 and 2, the crib mobile 2, which is battery powered, includes a base unit 8 and an arm 10 generally in the configuration of a J-tube extending from above the base unit 8. The base unit is configured to attach to a side of a baby crib. In this embodiment, as shown in FIG. 1, the base unit 8 is mounted to a side of the baby crib. As can be envisaged from FIGS. 2, 3, 5, 6, 7, 11 and 12, the base unit 8 is provided with an internally screw-threaded recess which is sized and shaped to receive a screw 12. The screw has a substantially enlarged flange 14 at the outer end. The base unit 8 is positioned at one side of the baby crib while the screw 12 is positioned at the other side of the crib. On inserting the screw 12 in the recess and tightening the screw 12 the base unit 8 and the screw 12 sandwiches the side of the baby crib such that it is securely mounted thereat. Opposite lateral sides and the front side of the base unit 8 are provided with a plurality of slots inside which speakers are situated. Sound or music played by the speakers is emitted through the slots. The upper end of the base unit is provided with an opening sized and shaped to receive a lower end of the J-tube 10. Four characters 16, 18, 20, 22 are hung at the upper end of the J-tube. The crib mobile 2 is configured such that the characters 16, 18, 20, 22 are rotatable in one of the available speeds. Further, lighting 24 is provided at the upper end of the J-tube. The lighting 24 is configured to be turned on in one of the available degrees of brightness or in the twinkling mode. In the twinkling mode, there is a plurality of speed of twinkling. Control switches 26, 28, 30, 32 are provided at opposite lateral sides and the front side of the base unit 8 for controlling the operation of the crib mobile 2. The operation of the crib mobile 8 includes the movement of the characters 26, 28, 30, 32 or the speed of the movement of the characters 26, 28, 30, 32, the lighting or the degree of brightness of the lighting from the crib mobile 2 and the playing of the music or which of the pre-programmed music is to be played. The crib mobile 2 and the base unit 8 are configured such that it can operate without a baby monitor unit 34 as shown in FIG. 8 engaged to the base unit 8.

The monitoring apparatus 1 comprises the monitor unit 34 for monitoring the activities of the baby in the crib. Specifically, in this embodiment, the monitor unit 34 is configured to monitor the baby audibly and visually. As clearly shown in FIG. 8, the monitor unit 34 includes a housing having a front member 36. The front member 36 is provided with a plurality of openings 38 behind which a microphone is located. The microphone is configured to receive sound from the surrounding thereof. In other words, the microphone is able to receive sound from the baby in the cot. The monitor unit also includes a camera 40 positioned at an upper end above the microphone. In this embodiment, five control buttons, namely buttons 42, 44, 46, 48, 50 are provided at the front member adjacent to the openings. The button 42 is an on-off button for turning on or off the monitor unit 34. The three buttons 44, 46, 48 are for the parent to select one of the three pre-programmed music. The button 50 is for adjusting the volume of the music. In use, the crib mobile 2 with the monitor unit 34 is positioned such that the view of the camera 40 can capture the activity area of the baby.

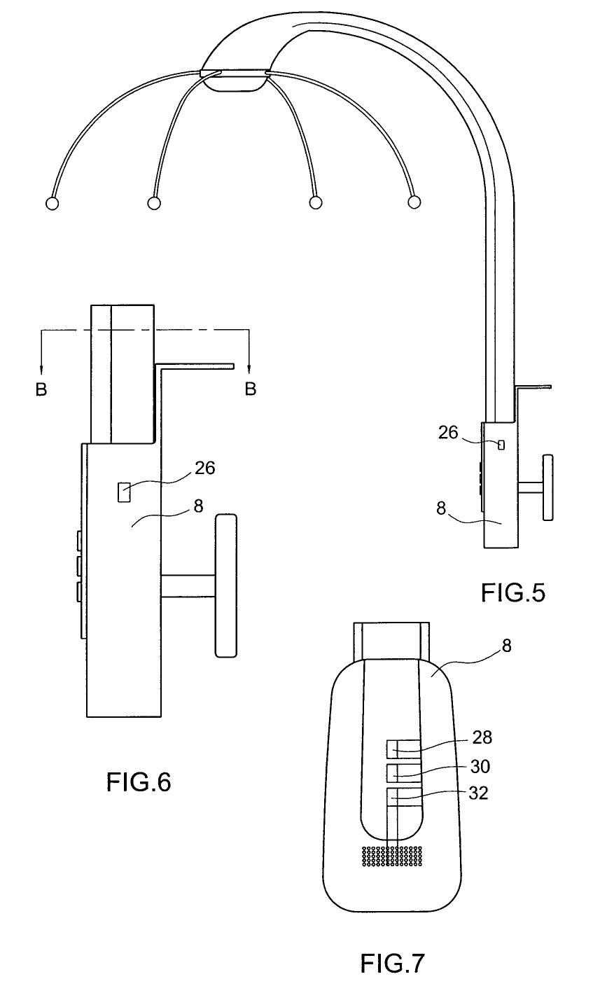

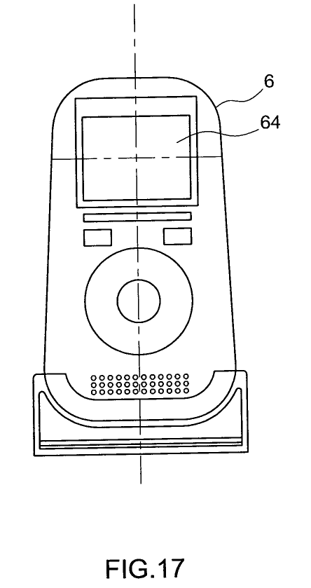

FIGS. 5, 6, 7, 9, 10, 11, 12, 14, 15 and 16 illustrate how the monitor unit 34 is detachably secured to the base unit 8. FIGS. 5, 6, 7, 9, 10, 11 and 12 show that at the front side of the base unit 8 there is provided a tongue-shaped member 51 extending from the upper end of the base unit 8 towards the lower end and ending at approximately two-third of the vertical length of the front side. The upper end of the tongue 51 is narrower and the lower end of the tongue 50 is wider. FIG. 10 shows that the tongue 51 has a pair of flanges 52, 54 laterally extending away from the outer end. A pair of grooves 56, 58 is defined behind the flanges 52, 54, and there is provided a plurality of metallic contact pins 60 in the grooves 56, 58. Turning to the monitor unit 34, as best seen in FIGS. 15 and 16, there is provided a recess 62 at a rear member of the housing of the monitor unit 34. The recess 62 is sized and shaped to receive the tongue of the base unit. Specifically, the recess has a narrower upper end and a wider lower end. It is envisaged that on downwardly sliding the monitor unit from above the tongue 51 and with the wider tower end of the tongue 51, the monitor unit 34 is secured to the base unit. The recess is likewise provided with a plurality of metallic contact pins, and their location is in agreement with that of the pins 60 of the tongue 51 when the monitor unit 34 is fully engaged with the tongue 50. Once the monitor unit 34 is fully engaged with the tongue 51, and the contact pins are in contact with each other, electrical connection between the monitor unit 34 and the base unit 8 is established and instructions for the operation of the crib mobile 2 can be fed from the monitor unit 34 to the base unit 8. The base unit 8 is likewise battery powered.

The camera 40 and the microphone of the monitor unit 34 seek to perceive the activities of the surroundings thereof audibly and visually. On perceiving the activities, video and audio signals corresponding to image and sound of the activities are transmitted via radio frequency to be received by the remote control unit 6. The remote control unit includes a receiver for decoding the radio frequency of the video and audio signals. The decoded video signal is then fed to a color liquid crystal display 64 provided at the remote control unit 6, and with the color display the parent can see the activities of the baby visually. The decoded video signal is then fed to a speaker provided at the remote control unit 6, and with the speaker the parent can hear the activities of the baby audibly. Please see FIGS. 1 and 17.

As can be seen from FIGS. 1 and 17, the remote control unit 16 is provided with a plurality of controls including internal controls and external controls. One of the internal controls is for turning on or off the power of the remote control unit. Some of the internal controls are for controlling the interface of the remote unit, for example, the brightness of the image of the from color screen, the volume of the speaker. However, the external controls are for controlling the operation of the monitor unit 34 and the crib mobile 2 remotely.

The remote control unit 6 is equipped with a transmitter configured to transmit radio frequencies. Each of the external controls is linked to a radio frequency and on actuating the control a corresponding radio frequency is emitted from the transmitter. The monitor unit 34 is equipped with means or a receiver for receiving and decoding the radio frequency from the remote control unit. Specifically, one of the external controls is for controlling the on-off status of the monitor unit 34 and on actuating this external control at the remote control unit 6, a corresponding frequency is emitted and on receiving this frequency by the receiver in the monitor unit 34, the monitor unit 34 will react accordingly.

In use, when the monitor unit 34 is fully engaged with the base unit 4, and when the parent carrying the remote control unit 6 is at a location remote from the crib mobile 3, the parent can turn on the crib mobile 2 remotely. Specifically, when the parent actuates the “power-on” control, the crib mobile 2 can be turned on. This is done when the monitor unit 34 receives the corresponding power-on radio frequency signal from the remote control unit 6, and consequently the crib mobile 2 is put in a stand-by mode. More specifically, signals are fed from the monitor unit 34 to the base unit 8 via the metallic pins causing the crib mobile 2 to enter this mode. In this stand-by mode, both the camera and the microphone are operational. Visual and audio information are then transmitted to the remote control unit. When the parent acquires the visual and the audio information remotely, the parent can then react accordingly. For example, if the baby in the crib being monitor is asleep, there is no need for action and the parent can simply leave the remote control unit on for continual monitoring of the baby. If the baby in the crib is crying, the parent can turn on the music and/or the motion of the characters remotely. The parent can select one of the available pre-programmed music that will work best in the particular situation to soothe the baby. Alternatively or additionally, the parent can actuate the control on the remote control unit 6 for turning on the twinkling light when, for example, the baby is crying in the middle of the night because the baby is afraid of the darkness.

The baby monitoring apparatus 1 according to the present invention is also unique because the crib mobile 2 can operate with or without the detachable monitor unit 34. When the crib mobile 12 is fitted with the monitor unit 34, it by itself is self-contained in that it in many ways functions as a conventional crib mobile, with instructions for the operation of the crib mobile are given at the crib mobile excluding the monitor unit 34. When the crib mobile 2 is fitted with the monitor unit 34, circuitry of the monitor unit takes over and overrides any previous instructions given on site. Specifically, once the monitor unit 34 is fitted to the base unit 8, instructions for the operation of the crib mobile 2 can be accepted at the monitor unit 34 itself or at the remote control unit 6. Further, the baby monitoring apparatus 1 according to the present invention provides a two-way communication between the crib mobile 2 and the remote control unit 6, and with this two-way communication, a more tailored interactive response from the parent can be provided to the baby.

Further, the crib mobile 2 without the monitor unit 34 and the monitor unit 34 with the remote control unit 6 can function independently. For example, the crib mobile 2 without the monitor unit 34 can be used on a first child at a baby cot and the monitor unit 6 with the remote control unit 6 can be used on a second child. This is advantageously because when a baby outgrows the use of a crib mobile, the monitor unit and the remote control unit can still be used for monitoring the activities of the baby and/or the crib mobile without the monitor unit can be used for another baby simultaneously.

It should be understood that the above embodiment of the present invention is illustrated by way of non-limiting example only, and features that are conventional in nature or understandable by a skilled person in the field are not explained in detail for brevity and clarity reason. For example, the type circuitries required in the base unit, the monitor unit and remote control unit for the working of the monitoring apparatus would be readily apparent to the skilled person. It is also to be understood that not all of the features described are essential and the present invention will still work when the non-essential features are absent. For example, in an alternative embodiment, the monitor unit may not be detachable from the base unit. In other embodiments, there may be provided one of more speakers at different location of the base unit. In yet other embodiment, a microphone may be provided at the remote control unit such that the parent can talk to the baby remotely at the speaker of the remote control unit. The monitor unit may be configured to be mountable on a wall. The base unit, the monitor unit and/or the remote control unit may be AC powered instead, or they may have in-built rechargeable batteries. Conversely, various features of the invention may also be provided separately or in any appropriate sub-combinations.

1. A baby monitoring apparatus comprising a crib mobile unit having a baby monitor unit and a remote control unit, wherein said baby monitoring apparatus is adapted and configured to allow a two-way wireless communication between said remote control unit and said crib mobile unit.

2. A baby monitoring apparatus as claimed in claim 1, wherein the two-way wireless communication is between said remote control unit and said baby monitor unit.

3. A baby monitoring apparatus as claimed in claim 1, wherein said baby monitor unit is detachable from the crib mobile unit and wherein said crib mobile unit is operable when said baby monitor unit is detached from said crib mobile unit.

4. A baby monitoring apparatus as claimed in claim 1, wherein said baby monitor unit is detachable from the crib mobile unit and wherein said baby monitor unit is operable when said baby monitor unit is detached from said crib mobile unit.

5. A baby monitoring apparatus as claimed in claim 1, wherein said crib mobile and/or said baby monitor unit includes a speaker for playing a pre-programmed music and a microphone for capturing audio from the surrounding of said speaker.

6. A baby monitoring apparatus as claimed in claim 1, wherein said baby monitor unit includes a camera for capturing video or color video in the view of said camera.

7. A baby monitoring apparatus as claimed in claim 1, wherein said remote control unit includes a speaker for playing an audio corresponding to audio captured by a microphone of said crib mobile or said monitor unit.

8. A baby monitoring apparatus as claimed in claim 1, wherein said remote control unit includes a video display for displaying a video or a color video corresponding to video or color video captured by a camera of said crib mobile unit or said baby monitor unit.

9. A baby monitoring apparatus as claimed in claim 1, further comprising a plurality of controls at said remote control unit and/or said baby monitor unit via which a user can provide instructions to said crib mobile unit for operation thereof.

10. A baby monitoring apparatus as claimed in claim 3, wherein said baby monitor unit is configured to provide with a recess for receiving a tongue from said crib mobile unit whereby said baby monitor unit is detachably secured to said crib mobile at said tongue.

11. A baby monitoring apparatus as claimed in claim 13, wherein said crib mobile unit and said baby monitor unit are electrically connectable by a plurality of metallic contacts via which instructions about the desired operation of said crib mobile from said remote control unit or baby monitor unit is fed to said crib mobile

12. A baby monitoring apparatus comprising:
(a) a crib mobile unit having a baby monitor unit; and
(b) a remote control unit;
wherein said baby monitor unit includes:
(c) a camera for capturing video or color video in the view of said camera and/or a microphone for capturing audio from the surrounding of said microphone; and
(d) a first transmitter for transmitting a first wireless signal corresponding to the video and/or the audio;
wherein said remote control unit includes:
(e) a second receiver for receiving the first wireless signal;
(f) a second transmitter for transmitting a second wireless signal corresponding to instructions received by said remote control unit for operation of said crib mobile unit; and
wherein said baby monitor unit further includes:
(g) a first receiver for receiving the second wireless signal.

13. A baby monitoring apparatus as claimed in claim 12, wherein said baby monitor unit is detachable from the crib mobile unit and wherein said baby monitor unit is operable when said baby monitor unit is detached from said crib mobile unit.

14. A baby monitoring apparatus as claimed in claim 12, wherein said crib mobile and/or said baby monitor unit includes a speaker for playing a pre-programmed music and a microphone for capturing audio from the surrounding of said speaker.

15. A baby monitoring apparatus as claimed in claim 12, wherein said baby monitor unit includes a camera for capturing video or color video in the view of said camera.

16. A baby monitoring apparatus as claimed in claim 12, wherein said remote control unit includes a speaker for playing an audio corresponding to audio captured by a microphone of said crib mobile or said monitor unit.

17. A baby monitoring apparatus as claimed in claim 12, wherein said remote control unit includes a video display for displaying a video or a color video corresponding to video or color video captured by a camera of said crib mobile unit or said baby monitor unit.

18. A baby monitoring apparatus as claimed in claim 12, further comprising a plurality of controls at said remote control unit and said baby monitor unit via which a user can provide instructions to said crib mobile unit for operation thereof.

19. A baby monitoring apparatus as claimed in claim 13, wherein said baby monitor unit is configured to provide with a recess for receiving a tongue from said crib mobile unit whereby said baby monitor unit is detachably secured to said crib mobile at said tongue.

20. A baby monitoring apparatus as claimed in claim 13, wherein said crib mobile unit and said baby monitor unit are electrically connectable by a plurality of metallic contacts via which instructions is fed to said crib mobile for desired operation of said crib mobile from said remote control unit or baby monitor unit.
